(19) United States
(12) Patent Application Publication
(10) Pub. No.: US 2009/0179759 A1
(43) Pub. Date: Jul. 16, 2009

(54) Animal deterrent system

(76) Inventors: Richard H. Koury, San Jose, CA (US); Richard A. Harris, San Jose, CA (US)

Correspondence Address: Richard H. Koury Sr., 1738 Shasta Avenue, San Jose, CA, 95128, US

(21) Appl. No.: 12/008,493

(22) Filed: Jan. 11, 2008

(51) Int. Cl. G08B 13/18; G02B 7/182

(52) U.S. Cl. 340/557; 359/865

(57) ABSTRACT

An animal detection and deterrent system enabling an out of doors area to be protected from intruding animals. A primary laser beam FIG. 1 (1.14) is produced from master laser/sensor (1.10), and precisely forwarded around an area of any configuration and topography via forwarders (1.11), (1.12), (1.13) or FIG. 10 (10.39), (10.40) and (10.41).

Master laser/sensor (1.10) and all forwarders, contain mechanisms to accurately adjust the direction of laser beams and position of light sensors. Light sensors contain filters to block ambient light and admit only laser light to allow operation in bright sunlight or darkness.

When the system is in a stable “on condition”, the laser beam ultimately strikes light sensor (6.65) in the master sensor (1.20). An animal interrupting the laser beam, at any point in the periphery, prevents laser light to strike light sensor (6.65) in master sensor (1.20). This causes light sensor (6.65) to initiate an electronic signal to an electronic circuit, FIG. 14, and microprocessor (14.102) mounted on circuit board (4.97).

Microprocessor (14.102) activates a deterrent system, causing the animal to vacate the area. Various deterrent systems can be employed including jetted water, pressurized air, fans, and gyrating balloon figures.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of the Invention

This invention relates to detecting and keeping wild animals and pets away from certain areas, out of doors.

2. Prior Art

Wild animals have been a continual nuisance to property owners for centuries. They eat peoples' plants, route soil, kill pets and plants and other acts that are undesirable to people. Pets can also be a nuisance by digging, urinating and defecating in planted areas and locations where people walk and play. Various techniques and products have been developed to keep animals away from private and public property without physically hurting the animals, or vegetation and soil.

Some of the more common prior patents utilize substances that are placed in the garden or on plants to discourage animals from coming near the areas where the substances are placed. U.S. Pat. Nos. 4,169,902, 6,159,474, 5,985,010, 6,372,240, 6,395,290, 4,965,070 and 5,738,851 are examples. Repellants listed in the above mentioned patents have several draw backs.

First they have to be continually applied, since watering, rain, and time remove them. This requires time of the user, which takes away from more productive time that could be spent in the garden. Second many of these repellants smell bad, and are offensive to the users as well as the animals for which they are intended. Third many of these substances are quite expensive and because they must be continually applied, their use results in a long term, significant cost.

Other patents utilize various sensors to detect animals in the area to be protected and employ various deterrents such as sound, ultrasonic vibrations, water, or projectiles of various types to frighten the animals away. Several patents, such as U.S. Pat. Nos. 5,658,093, 5,602,523, 6,104,283 and 6,710,705, however, do not define the type of motion sensor that would be utilized and therefore could be totally ineffective. If the motion sensor cannot be effectively employed around various perimeter configurations and sloping terrain or at a proper distance and cost, then the effectiveness and practicality of the deterrent is questionable.

Some prior patents, i.e. U.S. Pat. Nos. 5,870,972 and 6,615,770 specifies the use of infrared sensors to detect the body heat of animals, but this has distance limitations, as the animal must be in some proximity to the sensor to activate. Infrared sensors are also sensitive to human heat and invisible. If a property owner comes near his protected area he will set off the alarm, which could get to be annoying if the deterrent was a spray or audible sound blast. U.S. Pat. No. 6,407,670 mentions radar as a detector for animals, which is completely impractical for home owner applications.

Other prior art utilizes a non-laser infrared source and a receiver to detect deer. When the beam to the receiver is broken by an animal, an electronic circuit is activated which in turn sounds an alarm and or employs a deterrent of some type to encourage the animal to vacate the area. U.S. Pat. Nos. 5,009,192, 5,892,446, 6,373,385, 6,615,770 are examples of a non-laser infrared light beam detection system. These infrared detection systems also have several deficiencies.

Polychromatic, non-collimated infrared disperses in all directions as a function of distance from the infrared source. A similar phenomenon takes place with light in the visible spectrum, such as an automobile head light beam. The result is the intensity of light, per unit area, diminishes with distance with two significant results. The distance at which non-collimated infrared light can be detected is limited compared to coherent, highly collimated light such as a laser beam. The effective distance of non-collimated infrared is further compromised by other objects in its path, such as water droplets, falling leaves, birds, and branches all of which scatter and reflect the diffused infrared light.

At greater distances where the intensity of the polychromatic infrared beam is dispersed, and therefore weaker, any small obstruction in the beam, such as those mentioned above, can cause the receiver sensor to activate due to a lack of infrared light striking it. Furthermore, since the sun and most light sources have a component of infrared, the sensor can be fooled if light from these sources play on the receiver. The receiving sensor will stay activated even though an animal has obstructed the transmitted infrared source beam, and entered the restricted area.

U.S. Pat. Nos. 3,623,057, 5,063,288, 6,259,365, utilize a laser or undefined radiation beam to detect intruders through a perimeter, and generates an unspecified type of alarm. This system is directed at detecting human intruders and has no specific application for animal intrusion with suitable deterrent mechanisms. Further no mention is made as to how the laser is used and sensed. If it is not filtered, or electronically modified to separate it from white light, then ambient light can actuate the system and render it useless during the day.

If an automatic detection system is used to sense an unwanted animal, some form of deterrent must be employed to cause the animal to quickly vacate the area being protected. Prior art has employed various techniques to this end; one of the most common being ultrasonic waves or audible sound. These devices also have several deficiencies. First they are expensive due to the amount of electronics required and the cost of installation. If human audible sound is utilized, the noise becomes objectionable to the property owners and other people in the vicinity. Some of these devices are technically complicated such that they require technical installers. This makes the system expensive to install and maintain.

Many wild animals are creatures of habit. Deer, which are one of the biggest garden nuisances, demonstrate this characteristic by traveling the same paths and area over and over. Thus the same animals return to the same property and gardens to graze and find food. They are also trainable and this has been demonstrated by barking dogs that are penned up. Deer have quickly learned that the dog represents no physical harm to them, only a temporary annoyance, and ignore them. Likewise if deer hear the same sound over and over with no physical consequence they are likely to stay long enough to eat or at least destroy a plant, thus making noise or ultrasonic noise ineffective as a deterrent.

Prior art U.S. Pat. Nos. 6,615,770, 710,705 utilize ultrasonic waves, or sound, as a deterrent. Other prior patents use electric shock, flashing light, or water to deter the animal once detected, but these systems use various detection methods other than laser beam detection. Prior art U.S. Pat. Nos. 5,009,192, 6,700,486, 6,700,486 include water spray as a deterrent but the methods of detection are unspecified, or infrared, which has deficiencies as noted above.

### SUMMARY

A system for detecting and deterring intruding animals from entering a designated, out of doors, protected area.

In the drawings, identical objects and figures have the same number, prefixed by the Figure Number. For example object 10 shown in FIGS. 1 and 2 is designated as 1.10 and 2.10, respectively.

### DRAWINGS AND FIGURES

FIG. 1 shows a master laser/sensor and three laser forwarders, and laser beams in plan view as an example of an area protected from animals.

FIG. 2 shows a master laser/sensor, laser forwarders, solenoid valve, water pipes, and water nozzles in elevation view as an example of an area to be protected from animals. Note: The canopy 3.95, 4.95 and 5.95 shown in FIGS. 3, 4 and 5 are not shown in FIG. 2 for clarity.

FIG. 3 shows a front view of a master laser/sensor or a forwarder and its components.

FIG. 4 shows a side view of a master laser/sensor or a forwarder and its components.

FIG. 5 shows a three dimensional view of a master laser/sensor or a forwarder and its components.

FIG. 6 shows a section view of the sensor assembly showing light filters and a light sensor.

FIG. 7 shows a front view of a sensor assembly.

FIG. 8 shows a front view of a laser assembly.

FIG. 9 shows a section of a laser and laser housing.

FIG. 10 shows a plan view example of an area protected from animals with our laser system, where the laser beam forwarders are reflectors.

FIG. 11 shows a front view of a reflector assembly.

FIG. 12 shows a side view of a reflector assembly.

FIG. 13 shows a sectional view of a reflector housing and details of a horizontal angle dial.

FIG. 14 shows a schematic block diagram of the system electronics.

FIGS. 15-18 depict various laser pulses produced by lasers and a microprocessor in the system.

### DRAWINGS—REFERENCE NUMERALS

| | | | |
|---|---|---|---|
| 10 | Master laser/sensor | 11 | First forwarder |
| 12 | Second forwarder | 13 | Third forwarder |
| 14 | Primary laser beam | 15 | Second laser beam |
| 16 | Third laser beam | 17 | Forth laser beam |
| 20 | Master sensor | 21 | Master laser |
| 22 | First forwarder sensor | 23 | First forwarder laser |
| 24 | Second forwarder sensor | 25 | Second forwarder laser |
| 26 | Third forwarder sensor | 27 | Third forwarder laser |
| 28 | Solenoid valve | 29 | Source water pipe |
| 30 | Water nozzle supply pipe | 31 | Water Nozzle |
| 32 | Water Nozzle | 33 | Set screw |
| 34 | Middle housing | 35 | Laser beam angle α |
| 36 | Incidence & Reflection | 39 | First reflector forwarder |
| | angle Ø | | |
| 40 | Second reflector forwarder | 41 | Third reflector forwarder |
| 45 | Horizontal dial pointer | 46 | Vertical angle dial indicator |
| 47 | Screw | 48 | Lower hinge |
| 49 | Hinge shaft | 50 | Upper hinge |
| 51 | Vertical angle dial | 52 | Upper housing |
| 53 | Reflector | 54 | Spotting scope mount |
| 55 | Spotting scope | 56 | Set screw |
| 57 | Set screw | 58 | Sensor assembly |
| 59 | Laser assembly | 60 | Set screw |
| 61 | Set screw | 62 | Light filter |
| 63 | Reflective coating | 64 | Front polarizing filter |
| 65 | Light sensor | 66 | Rear polarizing filter |
| 68 | Front sensor housing | 69 | Rear sensor housing |
| 70 | End Cap | 71 | Vertical angle indicator line |
| 72 | Sensor electrical wires | 73 | Support plate |
| 74 | Vertical sensor magnets | 75 | Sensor ell bracket |
| 76 | Horizontal sensor magnets | 77 | Base plate |
| 78 | Screws | 79 | Set screw |
| 80 | Front filter housing | 81 | Rear filter housing |
| 82 | Laser electrical wires | 83 | Lower housing |
| 84 | Horizontal angle dial | 85 | Laser housing |
| 86 | Laser ell bracket | 87 | Laser horizontal magnets |
| 88 | Laser vertical magnets | 89 | Laser |
| 91 | Reflector assembly | 93 | Circuit board housing |
| 94 | Support post | 95 | Canopy |
| 96 | Solar cell panel | 97 | Electronic circuit board |
| 102 | Microprocessor | 103 | Audio Transducer |
| 104 | Ultrasonic Transducer | 105 | Deterrent Relay |
| 106 | Deterrent Relay | 107 | Green Light emitting diode |
| 108 | Red Light emitting diode | 110 | Rechargeable battery |
| 111 | Bridge rectifier | 112 | Five volt regulator |

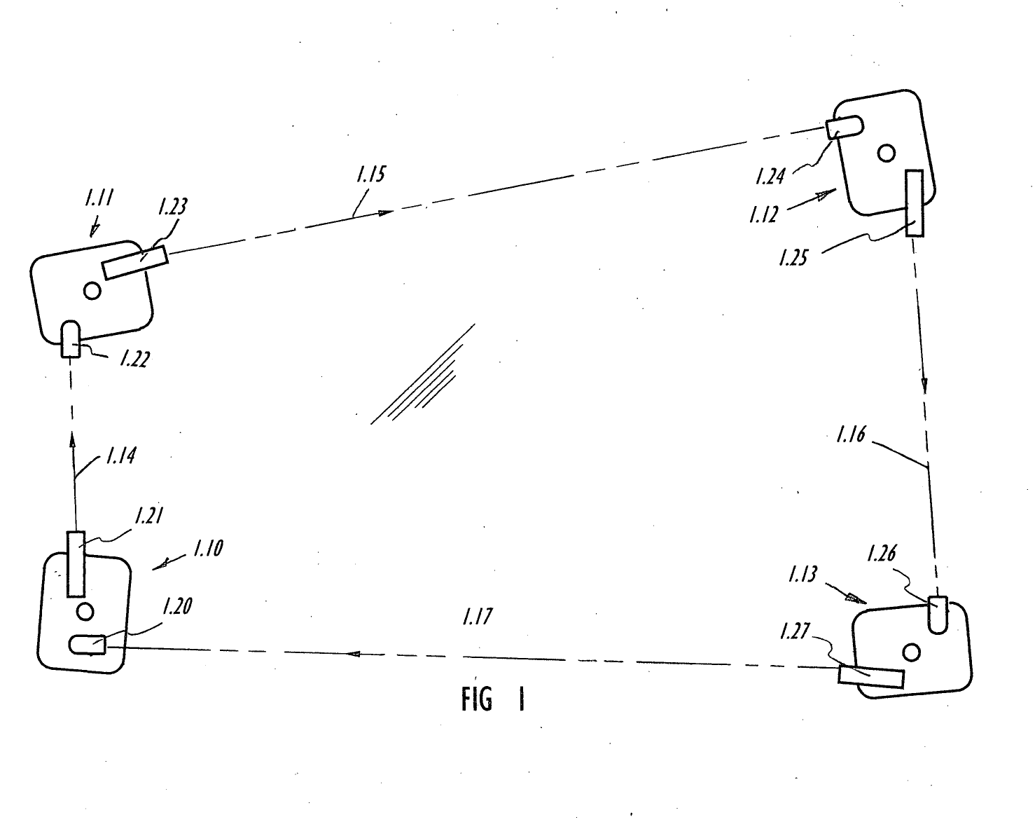

### DETAILED DESCRIPTION—FIGS. 1-18 EXAMPLE EMBODIMENT

FIG. 1 shows an example plan view of an area to be protected by intruding animals, such as deer, and a perimeter animal detection system consisting of a master laser/sensor 1.10 and three laser beam forwarders 1.11 1.12 and 1.13 respectively.

Several methods of forwarding the laser beam can be employed: two of which are explained in detail below. Any number of laser forwarders can be utilized to form various configurations of protected areas. Also depicted in FIG. 1 is primary laser beam 1.14 (a low power red beam) emanating from master laser/sensor 1.10 and second, third and fourth laser beams 1.15, 1.16 and 1.17, respectively emanating from first, second and third forwarders 1.11, 1.12 and 1.13 respectively.

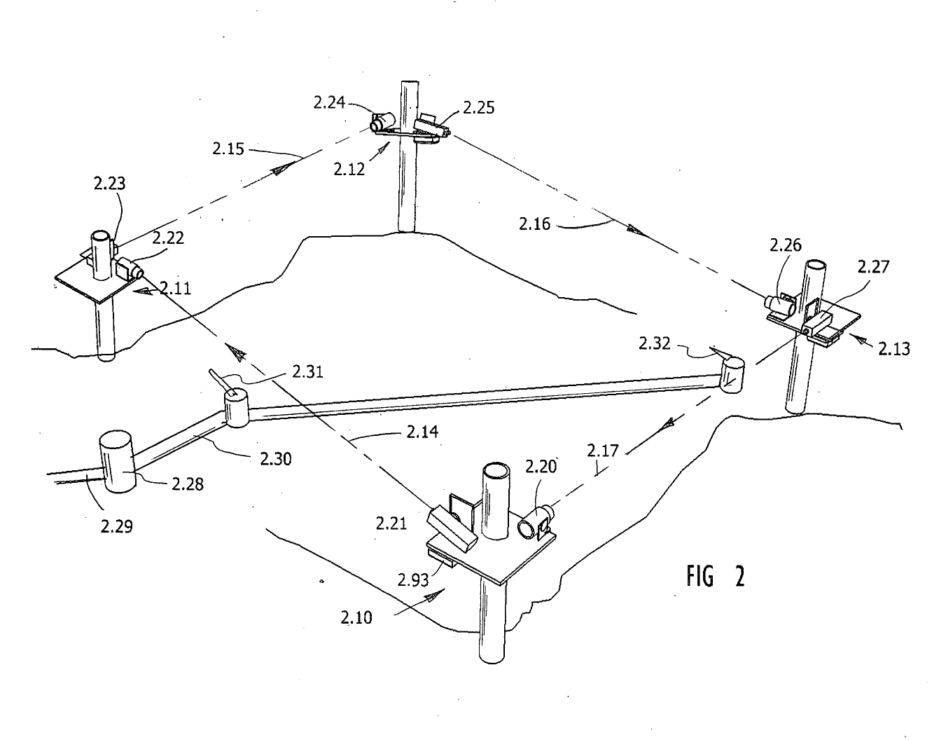

FIG. 2 depicts a similar detection system as shown in FIG. 1 but in an elevation view depicting hill topography. In addition an animal deterrent mechanism is shown, which in this case is jetted water from water nozzles 2.31 and 2.32. Various types of deterrent schemes can be employed in this system, such as compressed air, air inflated scarecrows, air driven streamers, balloon dancers, water with injected chemicals, and electric apparatus such as fans, and noise makers.

Master laser/sensor 2.10 is shown comprised of two basic components, master laser 2.21, and master sensor 2.20. Also shown are first, second and third forwarders 2.11, 2.12, and 2.13 respectively, and primary laser beam 2.14, and second, third and fourth laser beams 2.15, 2.16, and 2.17 respectively.

Each forwarder consists of two basic components. They are first, second and third forwarder lasers, 2.23, 2.25 and 2.27 respectively, and first, second and third forwarder sensors 2.22, 2.24 and 2.26 respectively. FIG. 2 also shows a source water pipe 2.29, a solenoid valve 2.28, a water nozzle supply pipe 2.30 and two water nozzles 2.31 and 2.32.

FIG. 3 shows a front view of master laser/sensor 1.10 or one of the forwarders 1.11, 1.12, 1.13

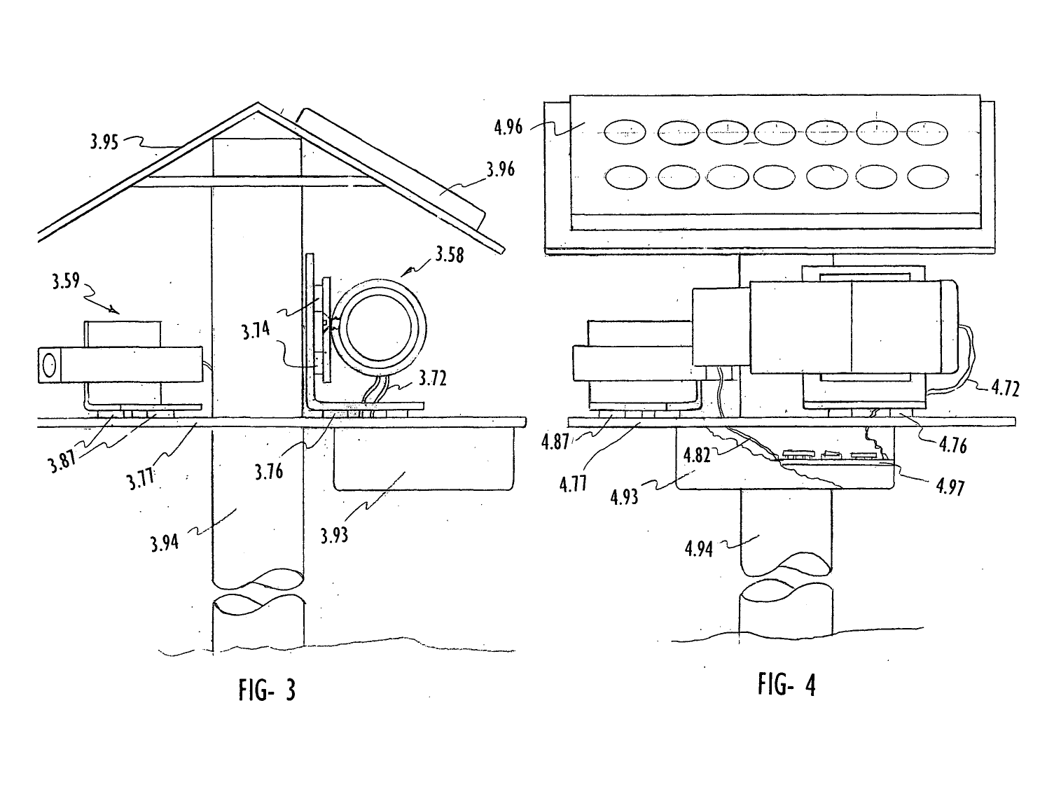

FIG. 4 shows a side view.

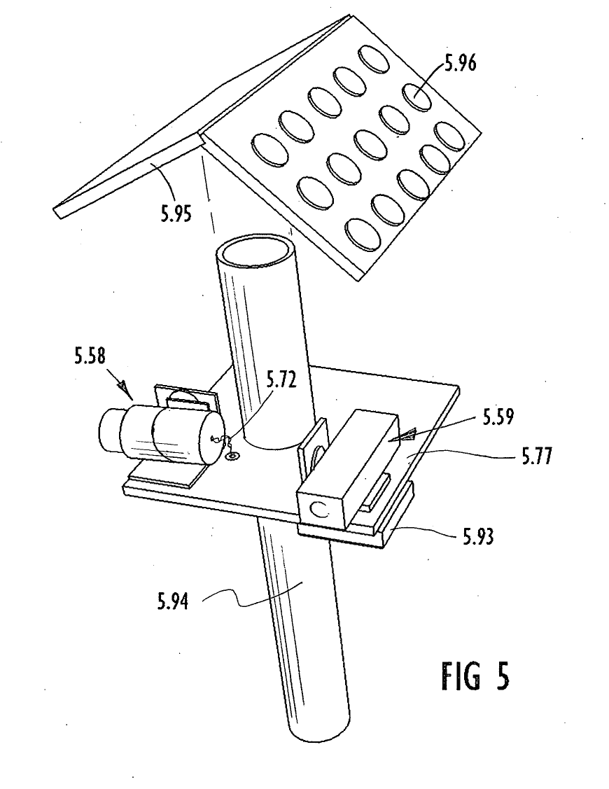

FIG. 5 shows a three dimensional view.

The basic components of master laser/sensor 1.10 and all forwarders are support post 3.94, 4.94, 5.94, base plate 3.77, 4.77, 5.77 laser assembly 3.59, and sensor assembly 3.58. And in addition electronic circuit board 4.97, circuit board housing 3.93, 4.93, 5.93, canopy 3.95, 4.95, 5.95, and solar cell panel 3.96, 4.96, 5.96. (Canopy 3.95, 4.95, 5.95, is omitted in FIGS. 1 and 2 for clarity.)

Support post 3.94, 4.94, 5.94 is mounted securely in the ground. Base plate 3.77, 4.77, 5.77, is mounted on support post 3.94, 4.94, 5.94. Canopy 3.95, 4.95, 5.95, resides on top of support post 3.94, 4.94, 5.94 and can pivot in the horizontal plane to provide shelter and shade to the components below. It also provides a convenient mounting location for solar cell panel 3.96. 4.96. 5.96, which can supply electrical power to laser assembly 3.59, 4.59 5.59, and to sensor assembly 3.58, 4.58, and 5.58 and electronic circuit board 4.97. Canopy 3.95, 4.95, 5.95, can be rotated to provide solar cell panel 3.96. 4.96. 5.96, with maximum exposure to the sun.

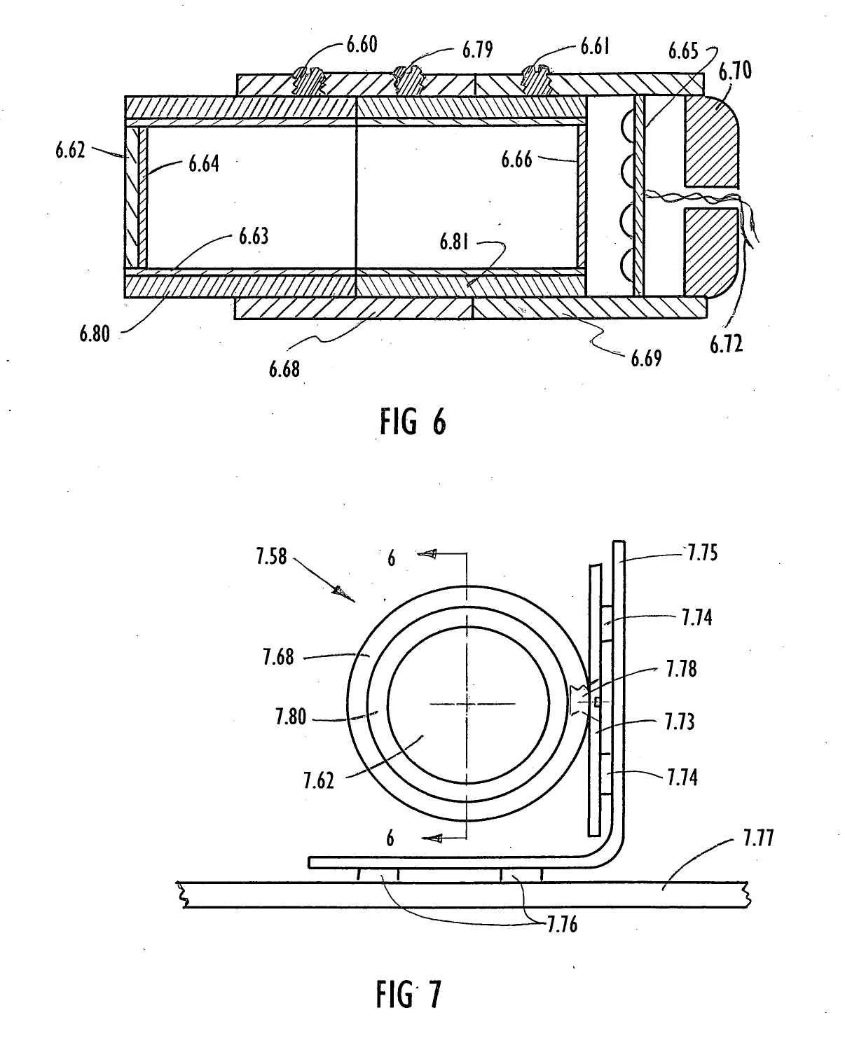

Sensor assembly 3.58, 4.58, 5.58 and laser assembly 3.59, 4.59, 5.59 are mounted on support plate 3.77, 4.77, 5.77 attached by magnets, shown in detail in FIGS. 6 and 7.

Circuit board housing 3.93, 4.93, 5.93 is mounted under base plate 3.77, 4.77, 5.77, and houses circuit board 4.97. Sensor electric wires 3.72, 4.72, 5.72, 6.72 and laser electric wires 4.82, 9.82 pass through base plate 3.77, 4.77, 5.77, and connect to circuit board 4.97.

FIG. 6 shows a cross sectional view through parts of sensor assembly 3.58,4.58, 5.58,6.58.

FIG. 7 shows a front view of sensor assembly 7.58.

Sensor assembly 7.58 is comprised of sensor ell bracket 7.75, which is attached to base plate 7.77 by horizontal sensor magnets 3.76, 4.76 7.76. Support plate 7.73 is held in place on sensor ell bracket 7.75 by vertical sensor magnets 3.74, 4.74, 7.74. Use of magnets as attachment components allow the sensor housings to be rotated in the vertical and horizontal planes quickly and accurately. Support plate 7.73 is attached to rear sensor housing 6.69 by screws 7.78.

Front filter housing 6.80 and rear filter housing 6.81 are mounted in the front and rear sensor housings 6.68 and 6.69 respectively. Set screws 6.60, 6.61 and 6.79 hold sensor housings firmly together. By tightening and loosening these set screws in different order, front filter housing 6.80 can be rotated independently of rear filter housing 6.81 or they can be rotated within the sensor rear housing 6.69, together as a subassembly.

Light sensor 6.65 is an opto-electric device and is mounted in rear sensor housing 6.69. Light sensor 6.65 can be a single opto-electric device or an array.

A light filter 6.62, 7.62, made of plastic or glass, and of the same color as the laser beam, is mounted in front filter housing 6.80, 7.80, and it filters out ambient light other than red light.

Light polarizing filters are also used to filter incoming ambient light. Front polarizing filter 6.64 is mounted next to light filter 6.62, 7.62. Rear polarizing filter 6.66 is mounted in rear filter housing 6.81. Reflective coating 6.63 covers the inner walls of front and rear filter housings 6.80, and 6.81 respectively.

End cap 6.70 fits inside rear sensor housing 6.69. Vertical sensor magnets 7.74 and horizontal sensor magnets 7.76 allow sensor assembly 7.58 to be grasped and rotated in the horizontal and vertical planes. This allows light sensor 6.65 to be precisely positioned to face a laser beam directed at it.

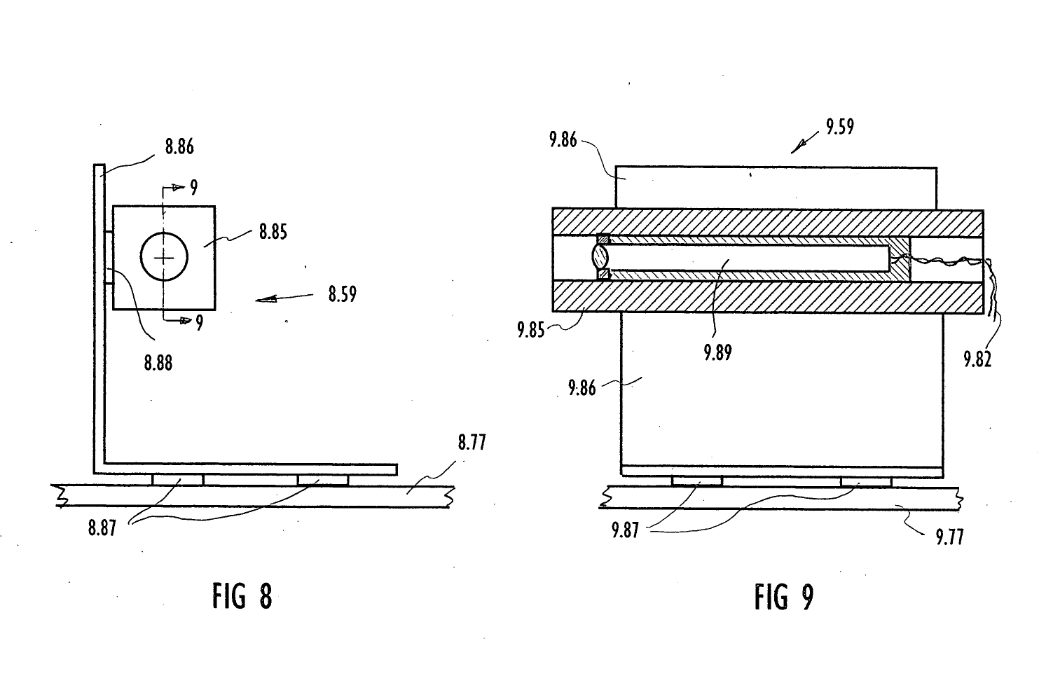

FIG. 8 is a front view of laser assembly 8.59.

FIG. 9 is a sectional view through laser 9.89, and laser housing 8.85, 9.85.

Laser 9.89, is mounted inside laser housing 8.85, 9.85 to protect it from dirt and moisture. Laser electrical wires 9.82 extend out the rear of laser housing 9.85 and into circuit board housing 3.93, 4.93, 5.93, where they connect to circuit board 4.97.

Laser housing 8.85, 9.85 is held in place against laser ell bracket 8.86, 9.86 by laser vertical magnets 8.88. Laser ell bracket 8.86, 9.86 is held firm to base plate 3.77, 4.77 5.77, 8.77, 9.77 by laser horizontal magnets 8.87, 9.87. The use of magnets to hold laser housing 8.85, 9.85 in place allow the direction of laser 9.89, to be adjusted easily and precisely in the vertical and horizontal planes.

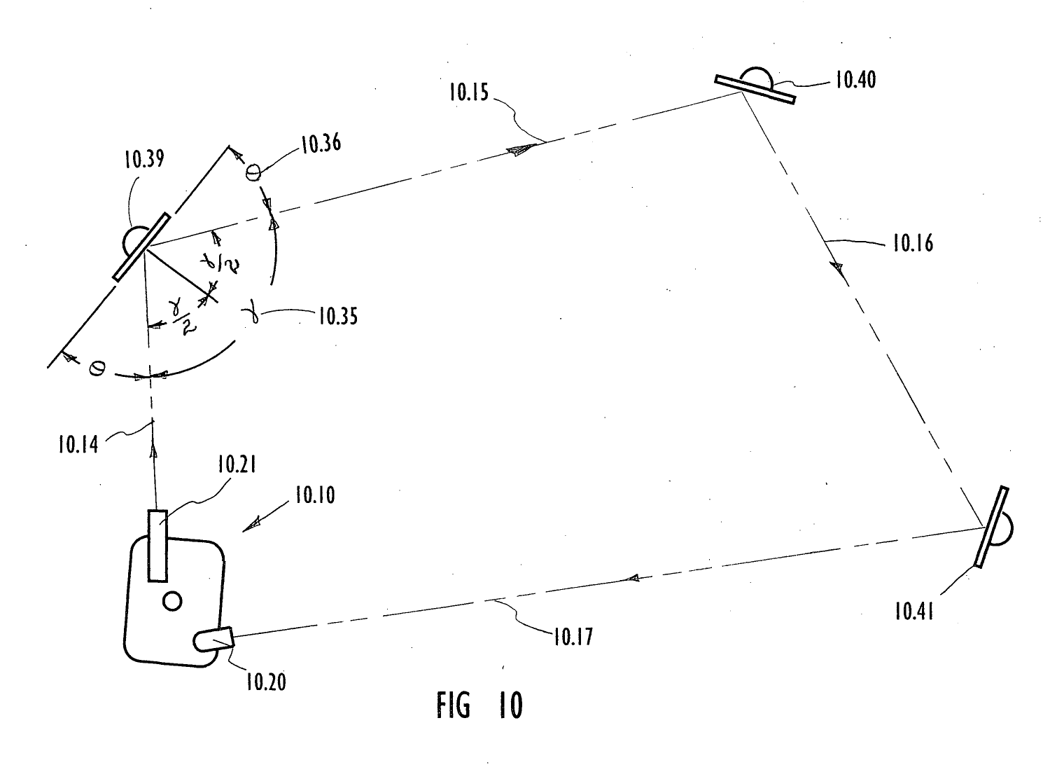

FIG. 10 shows a plan view of an example area protected by our laser detection system, but in this example the laser forwarders are reflectors. Primary laser beam 10.14 emitted from master laser/sensor 10.10 strikes first reflector forwarder 10.39 which reflects first reflected laser beam 10.15 to second reflector forwarder 10.40. Second reflected laser beam 10.16 is reflected by second reflector forwarder 10.40 to third reflector forwarder 10.41. Third reflector forwarder 10.41 reflects third reflected laser beam 10.17 back to master sensor 10.20 completing the laser beam protection periphery. Any number of forwarders can be utilized to configure a variety of protected areas.

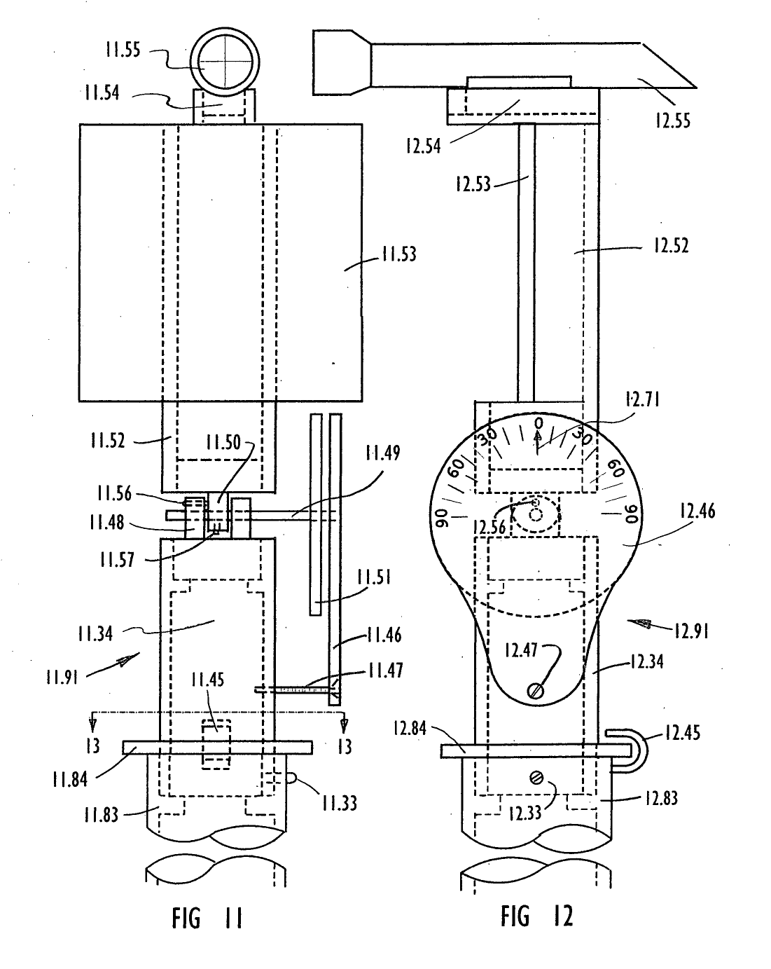

FIG. 11 and 12 show a front and side view respectively of a typical reflector forwarder such as first, second and third reflector forwarders 10.39, 10.40 and 10.41 respectively. This drawing shows only one of many ways that a reflector forwarder can be constructed.

Supporting the whole reflector assembly 11.91, 12.91 is a lower housing 11.83, 12.83, which can be mounted in the ground, in concrete or on wood or in any fashion that provides a firm stable base. Middle housing 11.34, 12.34, rests on top of lower housing 11.83, 12.83 and can rotate within lower housing 11.83, 12.83. Set screw 11.33, 12.33, when tightened against middle housing 11.34, 12.34, holds lower housing 11.83, 12.83 firmly to middle housing 11.34, 12.34.

Horizontal angle dial 11.84, 12.84, is mounted firmly to the circumference of middle housing 11.34, 12.34, such that if middle housing 11.34, 12.34, rotates, horizontal angle dial 11.84, 12.84, rotates with it.

Horizontal angle dial 11.84, 12.84, has angle marks in degrees printed on its surface ranging from zero to 90 degrees clockwise and 90 degrees counterclockwise. Horizontal dial pointer 11.45, 12.45, is mounted on lower housing 11.83, 12.83 and extends over the top of horizontal angle dial 11.84, 12.84, Horizontal dial pointer 11.45, 12.45, is made of clear plastic and has a black line painted or etched on its surface. This enables the degree marks on horizontal angle dial 11.84, 12.84, to be aligned and read in relation to horizontal dial pointer 11.45, 12.45.

If middle housing 11.34, 12.34, is rotated, horizontal angle dial 11.84, 12.84, will rotate below horizontal dial pointer 11.45, 12.45, and thus the number of degrees of rotation of middle housing 11.34, 12.34, and reflector 11.53, 12.53, can be noted.

Mounted on top of middle housing 11.34, 12.34, is a lower hinge 11.48. Upper hinge 11.50 is mounted to the bottom side of upper housing 11.52, 12.52 and extends downward between lower hinge 11.48. Hinge shaft 11.49 protrudes through holes in lower hinge 11.48 and upper hinge 11.50. Set screw 11.57 holds hinge shaft 11.49 firmly to upper hinge 11.50 so that upper housing 11.52, 12.52 can rotate freely, through a vertical plane, in lower hinge 11.48. Set screw 11.56, 12.56, located in lower hinge 11.48 can, however, be tightened against upper hinge 11.50, thus preventing rotation of hinge shaft 11.49 and upper housing 11.52, 12.52.

Reflector 11.53, 12.53 is mounted to upper housing 11.52, 12.52 and parallel to hinge shaft 11.49. Spotting scope mount 11.54, 12.54 is mounted on top of upper housing 11.52, 12.52 and reflector 11.53, 12.53, and perpendicular to the surface of the reflector 11.53, 12.53.

Vertical angle dial 11.51 is mounted firmly on hinge shaft 11.49, which protrudes through vertical angle dial 11.51 and vertical angle dial indicator 11.46, 12.46. Vertical angle dial indicator 11.46, 12.46 is mounted firmly to middle housing 11.34, 12.34 by screw 11.47, 12.47. Hinge shaft 11.49 is free to rotate within vertical angle dial indicator 11.46, 12.46.

Vertical angle dial 11.51 has printed on its face, degree lines and numerals ranging from zero at the top to 90 degrees in the clockwise direction and also 90 degrees in the counter clockwise direction. Vertical angle dial indicator 11.46, 12.46 is made of clear plastic and has a black vertical indicator line 12.71, printed on the top of its face. The numerals and degree lines on vertical angle dial 11.51 can be seen through the face of vertical angle dial indicator 11.46, 12.46. When upper housing 11.52, 12.52 is rotated, in a vertical plane, the vertical angle indicator line 12.71, on vertical angle indicator 11.46, 12.46 will indicate the number of angular degrees in the vertical plane through which upper housing 11.52, 12.52 and reflector 11.53, 12.53 have been rotated.

Spotting scope 11.55, 12.55 can be set into spotting scope mount 11.54, 12.54 which holds spotting scope 11.55, 12.55 firmly in position and perpendicular to reflector 11.53, 12.53. Spotting scope 11.55, 12.55 is held in spotting scope mount 11.54, 12.54 by friction and can be easily removed.

FIG. 13 is a sectional plan view through middle housing 11.34, 12.34, and shows horizontal angle dial 13.84, horizontal dial pointer 13.45 and middle housing 13.34. Angle degrees are shown printed on horizontal angle dial 13.84 and the arrow marker on horizontal dial pointer 13.45 is shown.

### Operation: FIGS. 1-10

Master laser/sensor 1.10 is firmly positioned in the ground at one corner of an area to be protected from animals. Forwarders 1.11, 1.12 and 1.13, for example, are likewise positioned at other points so as to form a perimeter around the area to be protected FIG. 1. Any number of laser forwarders can be used to form various protected area configurations.

Power is supplied to master laser/sensor 1.10, which causes primary laser beam 1.14 to be emitted from master laser 1.21. Next, master laser 1.21 and each forwarder laser, 1.23, 1.25, and 1.27, must be adjusted to point directly at each succeeding sensor. And each forwarder sensor, 1.22, 1.24, 1.26 and master sensor 1.20 must be rotated to point directly at the preceding laser beams, 1.14, 1.15, 1.16, and 1.17 respectively.

To accomplish this, positioning of all sensors 1.20, 1.22, 1.24, 1.26 is done first. First forwarder sensor 1.22 is grasped and rotated to point in the direction of master laser 1.21. Second forwarder sensor 1.24 is rotated to point in the direction of first forwarder laser 1.23. Third forwarder sensor 1.26 is pointed towards second forwarder laser 1.25, and master sensor 1.20 is pointed towards third forwarder laser 1.27.

The sensor assemblies 5.58 are held in place on the base plate 3.77, 4.77, 5.77, 7.77 and to sensor ell bracket 7.75, by magnets. This makes sensor assemblies easy to manipulate, by hand, in the vertical and horizontal planes.

The positioning of the sensors need not be precise since a laser beam entering light filter 6.62, 7.62 at most angles will be directed by reflective coating 6.63, through filter housings 6.80, and 6.81 to light sensor 6.65.

The lasers, however, need to be positioned precisely so that the beam enters the light filters of the sensors to which they are aimed. This can readily be accomplished by grasping laser assembly 3.59 and rotating it vertically and horizontally until the laser beam strikes the intended light sensor. This process is facilitated best in low ambient light when the laser beam can be seen easily. Laser vertical and horizontal magnets 3.87, 4.87, 8.87 and 8.88 respectively make positioning simple. For example in FIG. 2, master laser 2.21 is rotated, vertically and horizontally, so the beam strikes the light filter 6.62 and 7.62 of first forwarder sensor 2.22. This procedure is repeated around the protected perimeter adjusting each laser beam.

It is now necessary to minimize the amount of ambient light striking every light sensor 6.65 and at the same time maximize the amount of laser light entering every light filter 6.62, 7.62.

Light filter 6.62, 7.62 is of the same color as the lasers beams, which are red. It filters out all ambient light except for red light. A front polarizing filter 6.64 is mounted next to light filter 6.62, at the front filter housing 6.80. This polarizing filter 6.64 polarizes incoming ambient light causing its light waves into a single light plane. A rear polarizing filter 6.66 is mounted in front of light sensor 6.65, in rear filter housing 6.81.

By rotating front filter housing 6.80 and front polarizing filter 6.64, independent of rear polarizing filter 6.66, the amount of ambient light reaching light sensor 6.65 can be accurately adjusted. If front polarizing filter 6.64 is ninety degrees out of phase with rear polarizing filter 6.66, almost no ambient light will reach light sensor 6.65. As front polarizing filter 6.64 is rotated from a near total light blocking position, independent of rear polarizing filter 6.66, increasingly more light will be allowed to pass through both filters and strike light sensor 6.65.

The desired amount of light is determined by loosening set screw 6.61 and tightening set screws 6.79 and 6.60. This causes front filter housing 6.80, and rear filter housing 6.81, to be locked to front sensor housing, 6.68. Next the front and rear filter housings 6.80, and 6.81 respectively, and the front sensor housing 6.68 are removed from the rear sensor housing 6.69 as an assembly.

By looking through light filter 6.62, and polarizing filters 6.64 and 6.66 the amount of light passing through all filters can be seen and judged. This is best done by holding the assembly in the general direction in which it will be mounted in the rear sensor housing 6.69. By loosening set screw 6.60 and rotating front filter housing 6.80, 7.80, within front sensor housing 6.68, independent of rear polarizing filter 6.66, the amount of ambient light that will strike light sensor 6.65 is viewed and adjusted.

Normally the best adjustment provides for a minimum of ambient light to pass through all the filters. Once the desired amount of ambient light is established, set screw 6.60 is tightened and front and rear filter housings 6.80, and 6.81 respectively and front sensor housing 6.68 are thus fixed together again as a sub assembly.

It is now necessary to maximize the amount of laser light passing through all filters and striking the light sensor 6.65. By holding the filter sub assembly in front of rear sensor housing 6.69, but a short distance away, incoming laser light striking light sensor 6.65 can be viewed. Laser light is self polarizing. Thus at two points of axial rotation, 180 degrees apart, laser light passing through both polarizing filters and striking light sensor 6.65 will be brightest. This occurs as the laser polarized light aligns with either one of the polarizing filters.

The filter sub assembly, comprised of front filter housing 6.80, rear filter housing 6.81 and front sensor housing 6.68, is rotated until the laser light striking light sensor 6.65 is brightest. When this is observed the axial position of the sub assembly is maintained and the subassembly is inserted into rear sensor housing 6.69. Set screw 6.61 is tightened and the entire sensor assembly 3.58, 5.58, 7.58 is thus fixed in position and optimized for light sensor 6.65 to receive a minimum of ambient light and a maximum of laser light. Each and every sensor assembly 3.58, 5.58, 7.58 utilized is adjusted in this manner.

The above filter adjustment procedure causes the system to be optimized for any particular location, with respect to the sun and ambient light conditions. Light sensors will not be overpowered by ambient light, and will operate in broad daylight and night conditions. In extreme cases of direct sunlight shining into the light filter 6.62, 7.62, front filter housing 6.80 can be made longer and canopy 3.95, 4.95, 5.95, can be adjusted to shade the filters from direct sunlight as an added precaution.

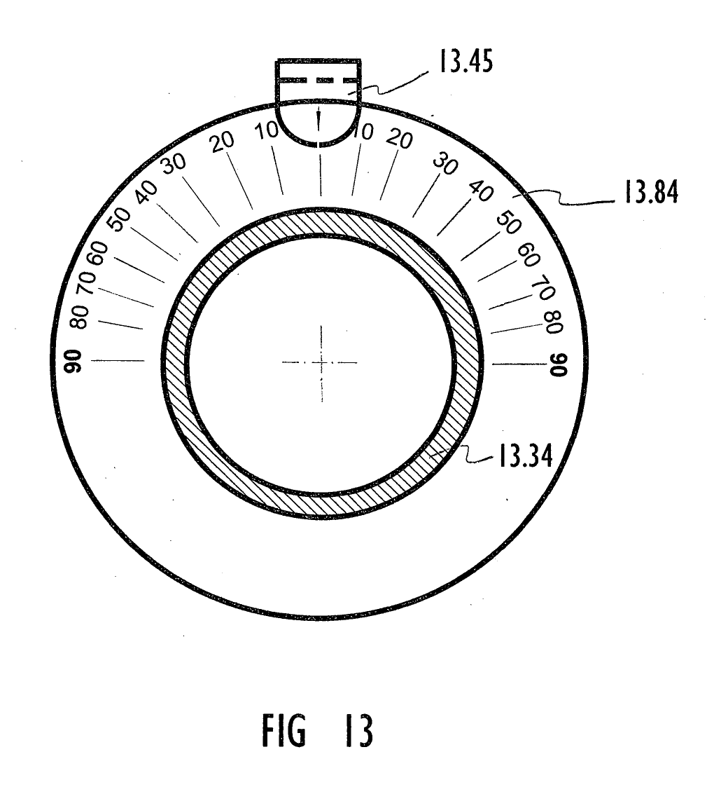

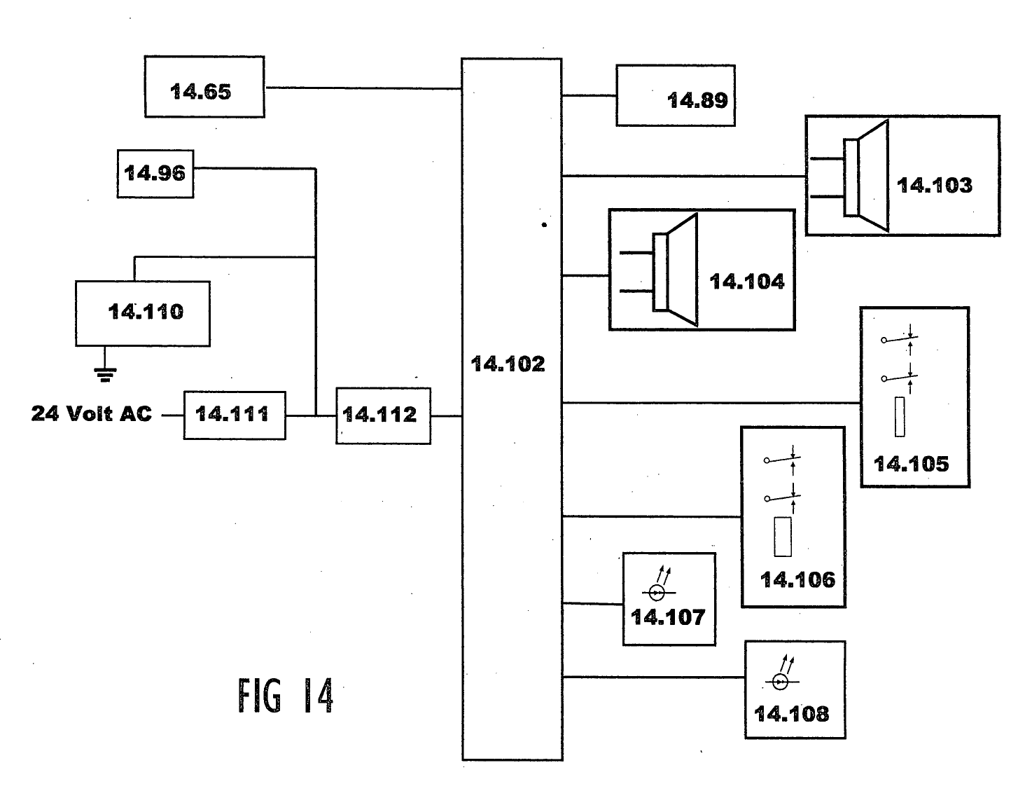

Light sensor 6.65, an opto-electric device, detects the presence or absence of laser light streaming through the filters and sends electronic signals to the electronic circuitry mounted on circuit board 4.97. The electronic function of the system is explained below and schematically depicted in FIGS. 14-18.

After the above operations are completed the electronic system is in a steady powered up condition and the entire protected area circled by a continuous, pulsed laser beam. An intruding animal, blocking the laser beam, will cause the electronic circuits described in FIG. 14 to function. The deterrent system will then be energized.

In this example a solenoid valve 2.28 would be actuated allowing water to flow through a source water pipe 2.29 to water nozzles 2.31 and 2.32. Water is jetted over the entire area being protected causing the intruding animal to vacate the area. A timer in the electronic circuit causes solenoid valve 2.28 to shut off after a predetermined time and the system would be automatically reset and ready to detect any other intruding animal.

If reflectors are used as the laser forwarders, as shown in FIG. 10, the set up of the system requires a different procedure. But the same master laser/sensor 1.10, 2.10, 10.10 is used and the interruption of the laser beam causes the same effect in the electronics and energizes a deterrent system.

FIGS. 11 and 12 show detailed components of reflector assembly 11.91, 12.91. When using reflectors as forwarders master laser/sensor 10.10 is used to generate primary laser beam 10.14 as described above. Master laser/sensor 10.10 is mounted firmly in the ground or concrete as are each of reflector forwarders 10.39, 10.40 and 10.41.

Primary laser beam 10.14 is adjusted so as to point directly at reflector 11.53, 12.53 of first reflector forwarder 10.39, using the techniques described above. Master sensor 10.20, of master laser/sensor 10.10 is pointed in the direction of third reflector forwarder 10.41.

Next first reflector forwarder 10.39 is adjusted to reflect primary laser beam 10.14 to reflector 11.53, 12.53 of second reflector forwarder 10.40. This is accomplished by mounting spotting scope 11.55, 12.55 into spotting scope mount 11.54, 12.54, on top of first reflector forwarder 10.39. Set screw 11.33, 12.33 and set screw 11.56, 12.56 are now loosened to allow middle housing 11.34, 12.34, upper housing 11.52, 12.52, reflector 11.53, 12.53 and spotting scope 11.55, 12.55 to rotate in a horizontal plane within lower housing 11.83, 12.83. Upper housing 11.52, 12.52 and reflector 11.53, 12.53 are also free to pivot in the vertical plane.

Looking through spotting scope 11.55, 12.55, cross hairs are aligned with primary laser beam 10.14 at the point it emanates from master laser 10.21. This insures that reflector 11.53, 12.53 in first reflector forwarder 10.39 is perpendicular to primary laser beam 10.14. And that the vertical angle between primary laser beam 10.14 and reflector 11.53, 12.53 in first reflector forwarder 10.39 has been established.

Set screws 11.33, 12.33 and 11.56, 12.56 are tightened to hold reflector 11.53, 12.53 in position. Next the numeric degree value printed on horizontal angle dial 11.84, 12.84, 13.84, under the arrow marker on horizontal dial pointer 11.45, 12.45, 13.45, is noted. Also the numerical degree value on vertical angle dial 11.51 under vertical angle indicator 11.46, 12.46 is noted. These readings are the “first angle readings”, at “position one”.

Set screws 11.33, 12.33 and 11.56, 12.56 are loosened again and reflector 11.53, 12.53 and upper housing 11.52, 12.52 are rotated so that the cross hairs, of spotting scope 11.55, 12.55 aligns to the center of reflector 11.53, 12.53 of second reflector forwarder 10.40.

Set screws 11.33, 12.33 and 11.56, 12.56 are now tightened fixing reflector 11.53, 12.53, of first reflector forwarder 10.39, perpendicular to an imaginary line from reflector 11.53, 12.53 in first reflector forwarder 10.39 to reflector 11.53, 12.53 of second reflector forwarder 10.40. This line of sight will eventually become laser beam 10.15. The horizontal and vertical degree values are now read on horizontal angle dial 11.84, 12.84, 13.84 and vertical angle dial 11.51. These readings are the “second angle readings”, at “position two”.

A law of physics states that the angle of incidence of a light beam striking a flat reflector is equal to its reflection angle. Thus the horizontal laser beam incidence and reflection angles φ 10.36, FIG. 10, between primary laser beam 10.14 and the reflector surface are equal; as are the vertical angles.

Laser beam angle α 10.35, measured between primary laser beam 10.14 and an imaginary line to reflector 11.53, 12.53 of second reflector forwarder 10.40, is equal to 180 degrees minus 2φ. This imaginary line of sight will eventually become laser beam 10.15.

Horizontal laser beam angle α 10.35 is determined by subtracting the degree values of “first angle readings”, noted above, from those of the “second angle readings” read above on horizontal angle dial 11.84, 12.84, 13.84. The vertical angle is determined by subtracting the degree values noted on vertical angle dial 11.51.

Since when the reflector 11.53, 12.53 or first forwarder 10.39 is properly positioned the angles of laser beam incidence and reflection angle φ 10.36 are equal, a line perpendicular to reflector 11.53, 12.53 will divide angle α into two equal angles α/2, FIG. 10.

Since α is known from the procedure above, α/2 gives the angles of rotation required of reflector 11.53, 12.53, from “position one”, for it to be in proper position to reflect primary laser beam 10.14 to forwarder 10.40.

By using the horizontal and vertical angle dials 11.84, 12.84, 13.84, and 11.51 respectively, reflector 11.53, 12.53 is again positioned back at “position one” at the “first angles” values. Reflector 11.53, 12.53 in first forwarder 10.39 can now be precisely rotated in the direction of forwarder 10.40 to values equal to α/2, again viewing horizontal and vertical angle dials 11.84, 12.84, 13.84, and 11.51 respectively.

Proper laser beam angles α 10.35, in the vertical and horizontal planes are now set to reflect primary laser beam 10.14 to the reflector 11.53, 12.53 of the second reflector forwarder 10.40. All set screws are now tightened to secure the position of forwarder 10.39.

To adjust reflector 11.53, 12.53 in second reflector forwarder 10.40 to reflect first reflected laser beam 10.15 to reflector 11.53, 12.53 of third reflector forwarder 10.41 the same procedure is followed as above. And likewise to adjust reflector 11.53, 12.53 of third reflector forwarder 10.41 to master sensor 10.20, the identical procedure is followed as described above. Once this alignment is accomplished the system is in a steady state mode encircling the entire periphery with a laser beam protecting the area from intruding animals.

FIG. 14 is a block diagram of the master electronics circuit for our system. Master laser/sensor 1.10 and each of the forwarders 1.11, 1.12 and 1.13 have a master electronics circuit in the form of a circuit board 4.97 mounted in circuit board housing 3.93, 4.93, 5.93. The component hardware on every circuit board 4.97 is identical. The character and function of each board is, however, different by virtue of the software program stored in a microprocessor's programmable, non-volatile memory. If, however, reflector forwarders are utilized, only the master laser/sensor 1.10, 2.10, 10.10 require a microprocessor 14.102.

Circuit board 4.97 can be powered from several different sources. Three are diagramed in FIG. 14 and are as follows:
1. The industry standard 24 volt Alternating Current used in lawn sprinkler systems.
2. A six volt rechargeable battery 14.110.
3. Solar cell panel 3.96, 4.96, 5.96, 14.96.

If 24 volt alternating current is used, it is rectified to direct current by onboard full wave bridge rectifier 14.111. In FIG. 14 all three power sources are summed together through isolation diodes which permits all three to be connected in the circuit at the same time. In addition solar cell panel 14.96 is connected to the rechargeable battery 14.110 such that solar cell panel 14.96 can simultaneously charge the rechargeable battery 14.110 and power the circuit. Proper voltage to the microprocessor 14.102 is maintained by five volt regulator 14.112.

The microprocessor 14.102 has a crystal oscillator which allows it to execute its software instructions on very precise intervals and durations of time. This capability gives microprocessor 14.102 the ability to interface between light sensor 14.65, and laser 14.89, in master laser/sensor 1.10, 2.10 and 10.10 and in each forwarder. Electrical signals from light sensor 14.65 are processed by microprocessor 14.102 and transferred to laser 14.89 such that laser light is emitted in precise durations of time or pulses.

System operation is initiated by laser 14.89 in master laser/sensor 1.10 emitting a laser beam pulse of relatively long duration. Light sensor 14.65 in first forwarder 1.11 detects the pulse of primary laser beam 1.14 and, through instructions from microprocessor 14.102 in first forwarder 1.11, laser 14.89 in first forwarder 1.11 emits an identical laser beam pulse to second forwarder 1.12 and the process is repeated around the perimeter. Once this process is complete the perimeter is surrounded by a stable pulsed laser beam and the system is considered in stable state.

Microprocessor 14.102, in master laser/sensor 1.10, detects that the system is in stable state by measuring the time it takes for its initial laser light pulse to travel around the perimeter through all of the forwarders and return to light sensor 14.65 in master laser/sensor 1.10.

Should an animal enter the protected area and block the laser beam at any point in the perimeter, the laser pulse time is disrupted and microprocessor 14.102, in master laser/sensor 1.10, detects the laser beam difference and is programmed to energize animal deterrent relays 14.105 and or 14.106. These relays in turn activate the deterrent system employed; in our example solenoid valve 2.28 and water nozzles 2.31 and 2.32.

Microprocessor 14.102 can be programmed in another, more sophisticated, way to accomplish the same control task. In this method microprocessor 14.102, in master laser/sensor 1.10, is programmed to sense a series of laser pulses called a “timing period”. This “timing period” is created by microprocessor 14.102 in master laser/sensor 1.10 and microprocessor 14.102, in each of the forwarders 1.11, 1.12, 1.13, contributing a laser pulse to the “timing period”.

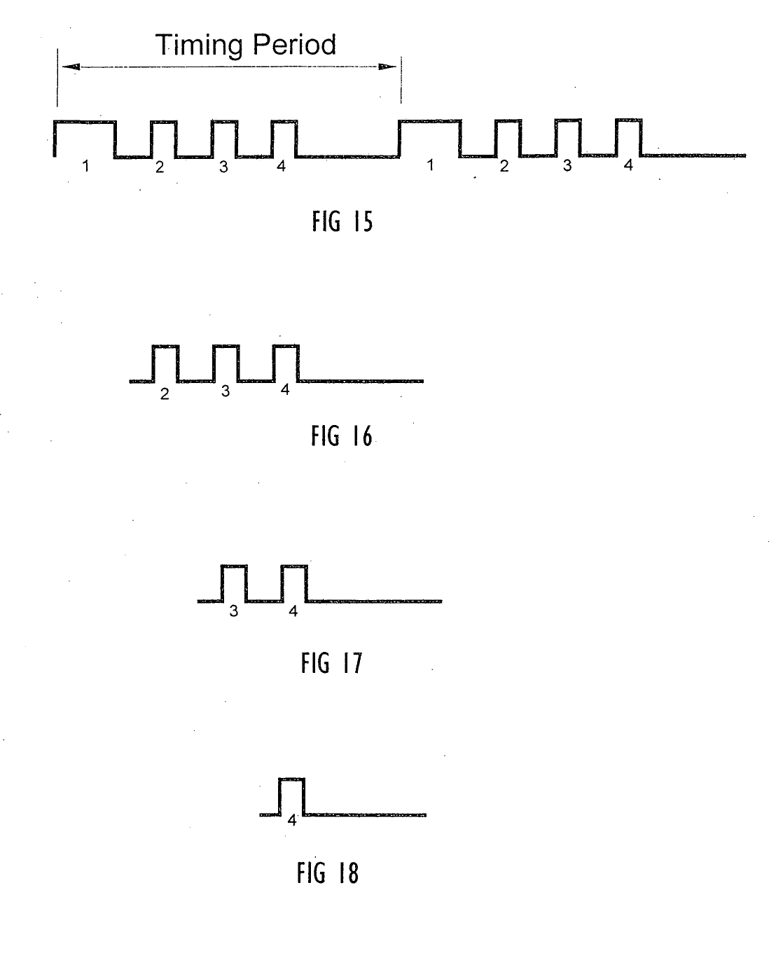

Specifically the process is initiated by microprocessor 14.102, in master laser/sensor 1.10 instructing laser 14.89 to emit a relatively long laser beam pulse, (1) FIG. 15, in this example approximately 30 milliseconds duration. This pulse is called a “synchronization pulse”, and is repeated, in this example, approximately every 250 milliseconds, which is the “timing period” FIG. 15.

When this “synchronization pulse” reaches light sensor 14.65 in first forwarder 1.11, microprocessor 14.102 in first forwarder 1.11, synchronizes its internal timing on the “synchronization pulse” and instructs laser 14.89 in first forwarder 1.11 to send the “synchronization pulse” to second forwarder 1.12. Microprocessor 14.102 in first forwarder 1.11, also adds an additional short laser pulse, (2) FIG. 15, of predetermined duration to the “synchronization pulse” and “timing period” at a predetermined interval.

This laser light pulse is now emitted towards second forwarder 1.12. When this pulse reaches light sensor 14.65, in second forwarder 1.12, microprocessor 14.102, in second forwarder 1.12 synchronizes its internal timing to the “synchronization pulse”, recognizes the short laser pulse generated by the previous laser/microprocessor and adds its own short laser beam, pulse 3 FIG. 15, in addition to the laser pulses received.

This process is repeated in each successive forwarder around the periphery until the final pulse, in our example, reaches light sensor 14.65 in master laser/sensor 1.10. The total laser light pulse, repeated twice, at this point looks like FIG. 15. Once this process is complete the perimeter is surrounded by a stable pulsed laser beam, repeating this pulse over and over, and the system is considered in stable state.

Should an intruding animal block the laser beam, the electronic system will respond slightly differently depending on where in the periphery the blockage occurs. If the blockage occurs in primary laser beam 1.14, between master laser/sensor 1.10 and the first forwarder 1.11, light sensor 14.65 in first forwarder sensor 1.22, will momentarily be denied primary laser beam 1.14. Microprocessor 14.102 in first forwarder 1.11 senses there is no “synchronization pulse” and emits, once only, one short pulse (2) FIG. 16. Then it reverts to a hold mode, emitting no laser beam, until it receives a “synchronization pulse” once again.

Light sensor 14.65, in second forwarder 1.12, also senses no “synchronization pulse” and it also adds its short pulse (3) FIG. 16, but only once, then goes into a standby mode until it again receives a “synchronization pulse”. Microprocessor 14.102 in forwarder three reacts in the same way. It senses no “synchronization pulse”, but two short pulses contributed by the two previous microprocessors in forwarders 1.11, 1.12. Microprocessor 14.102 in forwarder three then adds a short pulse (4) FIG. 16, only once. The total of all these short pulses looks like FIG. 16 and is transferred to light sensor 14.65 in master laser/sensor 1.10.

Microprocessor 14.102 in master laser/sensor 1.10 also senses no synchronization laser pulse, but it can detect the number of short pulses it receives. This tells microprocessor 14.102 in master laser/sensor 1.10 where in the perimeter the laser beam breech took place. Since in this case the blockage occurred in primary laser beam 1.14, microprocessor 14.102 in master laser/sensor 1.10 detects no “synchronization pulse”, and three short pulses; one from each of the forwarders 1.11, 1.12 and 1.13 FIG. 16.

If the blockage occurred in second laser beam 1.15 microprocessor 14.102 in master laser/sensor 1.10 would receive only two short pulses one each from second and third forwarders 1.12 and 1.13 respectively FIG. 17. If the break occurred in third laser beam 1.16 it would receive one short pulse FIG. 18.

When microprocessor 14.102 in master laser/sensor 1.10 receives no “synchronization pulse”, it energizes a deterrent relay 14.105 or 14.106 and the deterrent employed activates causing the animal intruder to vacate the area. Because the above described opto-electronic system detects where in the periphery the laser beam is blocked, microprocessor 14.102 in master laser/sensor 1.10 can be programmed to energize a deterrent located in that particular area. This provides for an efficient deterrent system and allows for economies in a large protected area.

As noted above when the laser beam is blocked in any location, master laser/sensor 1.10 activates a deterrent for a predetermined amount of time. After that time has elapsed, master laser/sensor 1.10 again starts transmitting “synchronization pulses”.

If, however, the laser beam remains blocked the system never achieves a new stable state and the system goes into a hold mode until the laser beam is restored around the periphery and all light sensors and microprocessors detect a “synchronization pulse”. Therefore if an object, such as a fallen tree branch, permanently blocks a laser beam, the deterrent will not stay activated indefinitely, but only the predetermined time for which it was programmed.

Microprocessor 14.102 is also programmed to activate lights and audio sounds from circuit board 4.97, by energizing light emitting diodes 14.107 and 14.108, audio transducer 14.103 and ultrasonic transducer 14.104.

Green light emitting diode 14.107 is located on circuit board housing 3.93, 4.93, 5.93 and would be on whenever the system is in steady state mode. Should the system be inoperative for any reason microprocessor 14.102 would be programmed to switch green light emitting diode 14.107 off, and turn on red light emitting diode 14.108 and audio transducer 14.103. This alerts the owner of a permanent laser beam blockage or a malfunction in the system. Ultrasonic transducer 14.104 is useful to deter certain animals from the protective area.

### Advantages

From the description above, a number of advantages of some embodiments of our animal deterrent system become evident:
(a) The deterrent system can be adapted to small or large areas, with various slopes and contours.
(b) Since most property owners can easily and economically install the system without the need for specialty installers, initial costs are low.
(c) Should professional installation be required the cost would still be low compared to other property improvements, since labor to do so is not extensive.
(d) The system can easily be altered or expanded in configuration to protect a different area from one initially established.
(e) A great advantage is that the system will automatically work effectively in bright sun or night conditions and in a variety of changing ambient lighting conditions.
(f) The system will not annoy the property owner employing the system or neighbors thus making it user friendly.
(g) The system can operate effectively over long distances, several hundred yards, allowing for commercial applications on golf courses or ranches for example.
(h) Because the system described above saves the user substantial money in protection of lost scrubs, plants and crops, the cost of purchase and installation is paid for in a short amount of time.
(i) Operational costs of the system are minimal.
(j) The system can be adapted to a wide range of intruding animals or even humans, because of its positioning capability and range.
(k) The animal deterrent described above provides all the parts and methods needed to provide a complete and flexible animal deterrent system, not just components and vague ideas.

Accordingly, the reader will see that the animal deterrent system of the various embodiments can be employed in a variety of locations under various ambient weather conditions to effectively, yet harmlessly keep animals from certain areas. The system can be manufactured and sold at reasonable costs, and installed by homeowners and property owners, thus making it practical and economical. Most important it is an effective, complete, and lasting solution to animal intrusion. It encompasses all the essential elements of animal control, including effective detection, variety of deterrent options, low initial and ongoing costs, versatility, and expandability.

1. A system for detecting and deterring intruding animals from entering a designated, out of doors, protected area comprising:
(a) a master laser producing a laser beam, and
(b) forwarder means to accurately direct said laser beam in a continuous peripheral configuration, around a predetermined area, and
(c) a light sensor for detection of presence and interruption of said laser beam, and
(d) a light filter with means to exclude ambient light to said light sensor, while admitting said laser beam in full daylight or darkness, and
(e) an electronic circuit with means to intelligently interpret signals from said light filter and to relay control signals to external components, and
(f) an activation means of an animal deterrent system, upon detection of an interruption of said laser beam.

2. The master laser of claim 1 wherein said laser beam is uniquely pulsed and encoded at a predetermined rate and configuration.

3. The master laser of claim 1 further including adjustment means to accurately direct said laser beam in the vertical and horizontal plane.

4. The forwarder of claim 1 further including a light sensor capable of detecting an incoming uniquely pulsed and encoded laser beam.

5. The forwarder of claim 4, further including a laser controlled by an electronic circuit, such that it is capable of emitting modified pulse coded laser beams.

6. The light sensor of claim 1 including an opto-electric device capable of transmitting electrical pulses when laser light strikes its surface.

7. The light filter of claim 1, further including independently adjustable polarizing light filters.

8. The light filter of claim 1 further including a lens of the same color as said laser beam.

9. The light filter of claim 1 further including a reflective means to direct laser light to said light sensor.

10. The light filter of claim 1 further including a notch light filter admitting primarily light with frequencies of the laser beam only.

11. A system for detecting animals encroaching into an area by surrounding the area with a laser beam and employing a deterrent system to cause intruding animals interrupting said laser beam to vacate said area comprising:
(a) a laser producing a laser beam, and positioning mechanism to direct said laser beam to a laser forwarder, and
(b) said forwarder with means to detect incoming said laser beam and accurately produce and direct an outgoing000 laser beam to successive forwarders so as to completely surround an area to be protected by intruding animals, and
(c) a opto-electric light sensor with means to detect the presence or absence of said laser beam, with means to transmit electronic signals according to, and dependent on, the presence or absence of laser light striking it.
(d) a light filtering means to transmit said laser beam to the exclusion of ambient light in bright daylight or total darkness and,
(e) an electronic circuit, operating in conjunction with said light sensor, and said transmitted electronic signals, activating an animal deterrent system.

12. The forwarder of claim 11 consisting of reflective surfaces.

13. The deterrent system of claim 11 wherein said deterrent system is water, jetted from nozzles.

14. The deterrent system of claim 11 wherein said deterrent is a gyrating balloon filled and activated with blown air.

15. The deterrent system of claim 8 wherein said deterrent is a chemical spray.

16. A method of orientating the position of a first reflective surface so as to reflect a laser beam hitting its surface to a second reflective surface or target
(a) providing a laser beam to be directed at said first reflective surface located at any distance away, from laser source.
(b) providing a first means for sighting from said first reflective surface, so as said line of sight is perpendicular to plane of reflective surface,
(c) providing a second means of accurately rotating said reflective surface in the horizontal and vertical plane,
(d) providing a third means for noting horizontal and vertical angle position of said first reflective surface,
(e) rotating, by said second means, first reflective surface in the horizontal and vertical plane and,
(f) sighting by said first means so as said line of sight is aimed directly at source of said laser beam.
(g) using said third means, noting and recording the horizontal and vertical angle position of said first reflective surface and recording these angles as a first position.
(h) rotating, by said second means, first reflective surface in the horizontal and vertical plane and,
(i) sighting by said first means so as said line of sight is aimed directly at said second reflective surface or target,
(j) using said third means, noting and recording the current horizontal and vertical angle position of said first reflective surface and recording these angles as a second position,
(k) subtracting said horizontal and vertical angle values recorded at first position from those at second position thus,
(l) establishing horizontal and vertical angles reflector surface moved from facing said laser to facing said first reflective surface, and defining these angles as laser beam angles.
(m) Dividing laser beam angels by two and thus obtaining required horizontal and vertical angles of rotation for first reflective surface from first position.
(n) rotating by said second means, and using third means re-establish position of said first reflector at said first position horizontal and vertical angles.
(o) rotating, by said second means, first reflective surface in the horizontal and vertical plane from zero position towards second reflector and,
(p) using third means establish position of said first reflective surface at horizontal and vertical angular values equal to said angles of rotation,
(q) providing a means to fix solidly position of said first reflective surface;
whereby a reflective surface is positioned accurately to reflect a laser beam directed at it to another desired target and allow a series of reflective surfaces to be quickly and accurately positioned to reflect accurately a laser beam around a given, predetermined periphery.
